(19) United States
(12) Patent Application Publication
(10) Pub. No.: US 2004/0246713 A1
(43) Pub. Date: Dec. 9, 2004

(54) Flashlight

(76) Inventor: Jeong-Kook Kwak, Seoul (KR)

Correspondence Address: Ira J. Schultz, DENNISON, SCHULTZ & DOUGHERTY, Suite 612, 1745 Jefferson Davis Highway, Arlington, VA, 22202, US

(21) Appl. No.: 10/637,687

(22) Filed: Aug. 11, 2003

(30) Foreign Application Priority Data
Jun. 9, 2003 (KR) 2003-0036753

(51) Int. Cl. F21L 4/04

(52) U.S. Cl. 362/202

(57) ABSTRACT

A flashlight improves the intensity of light in the large scale by using a single LED and a reflection mirror, thereby simplifying the structure and reducing the manufacturing cost.

In the flashlight including a head and a case coupled with the head, the head part includes a transparent plate fixed to a front surface part of the head, a reflection mirror mounted to a rear surface of the transparent plate with a predetermined inclination angle for collecting light, a circular LED fixing part mounted in the center of the reflection mirror via a hole formed in the center and fixing an LED, and a circular LED supporting part fixed to a rear surface of the LED fixing part for supporting the LED not to be deviated from the LED fixing part, wherein the LED fixing part and the LED supporting parts are mounted around the LED, so that the heat generated from the LED is emitted to the outside and the coupled LED fixing and supporting parts serve as a negative terminal.

### BACKGROUND OF THE INVENTION

(a) Field of the Invention

The present invention relates to a flashlight, in which the structure of a reflection mirror and a light emitting diode LED are modified for improving the intensity of light of the flashlight by a single light emitting diode in a large scale, thereby simplifying the structure and reducing the manufacturing cost thereof.

(b) Description of the Related Art

In general, a flashlight is structured to easily carry by using batteries and a switch for alternatively turning on or off the power applied from the batteries to blink a bulb.

A prior art flashlight utilizes a bulb incorporating filaments to generate light. The applicant of this invention has suggested a flashlight to generate light by using a plurality of light emitting diodes.

Such prior art flashlight has, however, disadvantages that the structure of the flashlight becomes complicated by using the plurality of LEDs, and that the manufacturing cost becomes increased accordingly. Further, it is not impossible to maintain the optimum state as a flashlight since the intensity of the light is weak in spite of the use of the plurality of LEDs.

### SUMMARY OF THE INVENTION

Therefore, the present invention is derived to resolve the above problems of the prior art and has an object to provide a flashlight of which the intensity of light is largely improved by modifying the structure of a reflection mirror and the structure of an LED coupling portion.

In order to achieve the above and other advantages and in accordance with the purpose of the present invention, as embodied and broadly described, in a flashlight including a case and a head part coupled with the case, the head part includes a transparent plate fixed to a front surface part of the head, a reflection mirror mounted to a rear surface of the transparent plate with a predetermined inclination angle for collecting light with a reflexibility of R100.5, a circular LED fixing part mounted in the center of the reflection mirror via a hole formed in the center and fixing an LED, and a circular LED supporting part fixed to a rear surface of the LED fixing part for supporting the LED not to be deviated from the LED fixing part.

According to another aspect of the present invention, in a flashlight including a case and a head part coupled with the case, a switch is mounted in a switch cover with a positive terminal exposed to the outside and another positive terminal connected to the LED supporting part via a spring, and an insertion part is interposed between the head and the case and formed with a spiral part, wherein the spiral part of the insertion part is coupled with a spiral part formed inside a rear part of the head and a spiral part formed inside of a head part of the case.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a perspective view showing a whole flashlight according to a preferred embodiment of the present invention, which is disassembled;

FIG. 2 is a detailed view showing an LED fixing part of FIG. 1;

FIG. 3 is a cross-sectional view of a flashlight according to another preferred embodiment of the present invention;

FIG. 4 is a detailed view showing a switch fixing part of FIG. 3;

FIG. 5 is a view showing a switch fixing element according to another preferred embodiment of the present invention; and

FIG. 6 is a view showing a connection portion in a case of the flashlight of the present invention.

### DETAILED DESCRIPTION OF PREFERRED EMBODIMENTS

The present invention will be explained in more detail with reference to preferred embodiments in junctions with the attached drawings.

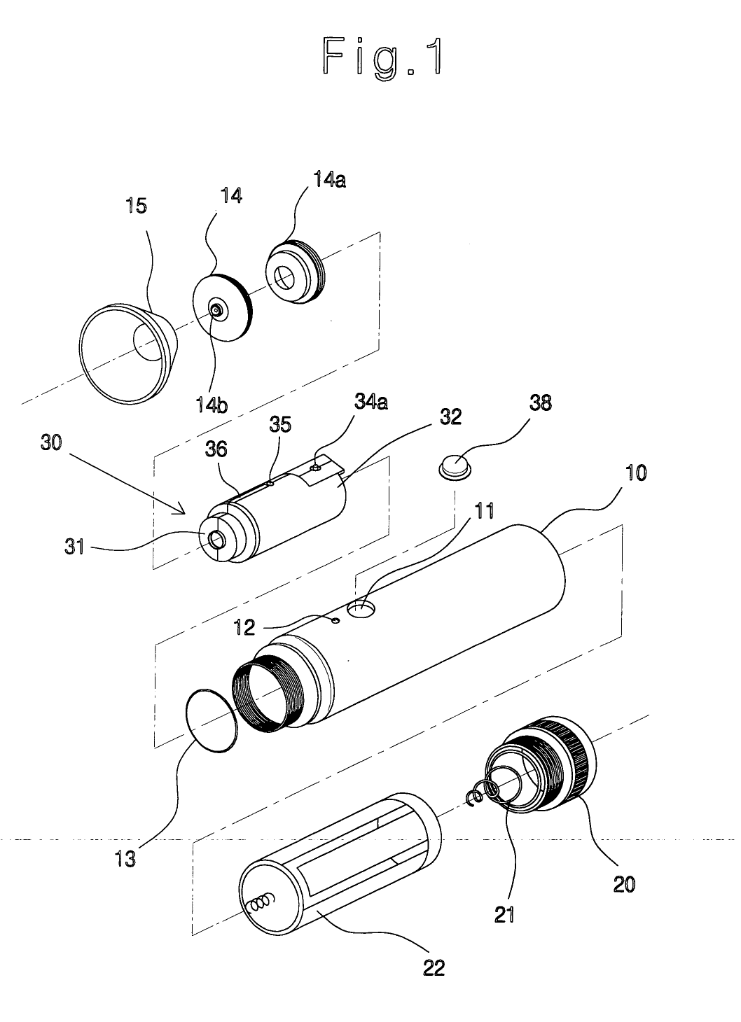

FIG. 1 is a perspective view for showing the structure of a disassembled switch of a flashlight according to the present invention. In FIG. 1, a cylindrical metal case 10 is formed with a plurality of holes 11, 12 at an upper end part and coupled with a rubber ring 13 at a side.

The case 10 is mounted with a switch 30 that is inserted into the cylindrical body part thereof, and a button 34a and a display light 35 are inserted into the holes respectively.

A circular LED supporting part 14a is spirally fitted into the case 10 while the LED supporting part 14a is compressed and fixed to a rear surface of a circular LED fixing part 14 that includes an LED 14b. A head 16 is mounted with a transparent plate 17 on a front surface and a reflection mirror 15 inside, wherein the reflection mirror is inclined by a predetermined angle. In the center of the reflection mirror 15, the LED 14b is inserted to be protrudedly.

The LED 14b is preferably a Lumi LED and a reflexibility of the reflection mirror is preferably R100.5.

The case 10 is coupled with a lid 20 at a rear surface via a battery case 22 that secures batteries. The lid 20 is formed with a spring 21 inside for compressing the battery case22. The lid 20 is further formed with a hole 53 for fixing a handle strap.

The switch 30 is inserted into the case 10 at positions corresponding to the holes 11,12.

The switch 30 includes a switch body part 31 in the hemispheric shape, and a cover 32 coupled with the switch body part by protrusions and the like while facing the switch body part.

The switch main body 31 is mounted with a printed circuit board in the center, and provided with a switch assembly with the button 34a, the display lamp 35 for displaying the consumption of the batteries, and a negative terminal 36 contacting the inner surface of the case at a side of the printed circuit board.

The switch cover 38 is mounted outside the switch button 34a to be positioned in the hole 11 for waterproof function.

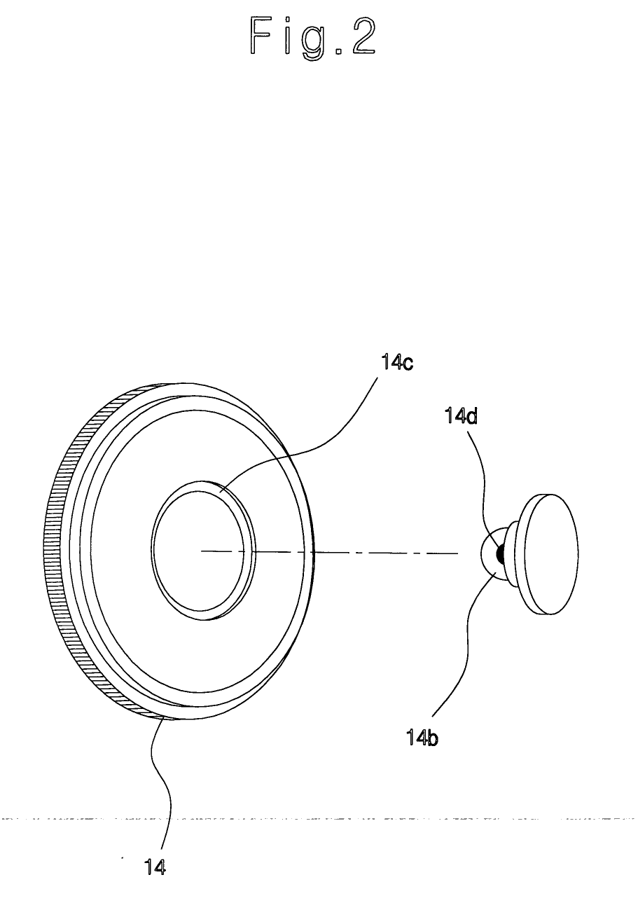

FIG. 2 is a detailed view showing the LED fixing part 14. In FIG. 2, the LED fixing part is formed with a fixing groove 14c at a side for inserting and fixing the LED 14b into the fixing groove 14c.

The flashlight of the present invention as described above employs a single LED 14b and the reflection mirror 15 of a predetermined inclination angle instead of any bulb or a plurality of LEDs for obtaining the high intensity of light. In the present invention, the reflection mirror 15 is fitted in the head 16 while the transparent plate 17 is fixed to the front surface of the head, and the LCD 14b is inserted into the head via the hole formed in the center of the reflection mirror 15.

The LED 14b is in the shape of chip and fixed in the fixing groove 14c of the LED fixing part 14, wherein a yellow filament 14d in the LED 14b is exposed upwardly.

The LED fixing part 14 is mounted with a LED supporting part 14a on the rear surface by pressing in order to avoid the deviation of the LED 14b as well as emitting the heat generated from the LED 14b.

The LED fixing part 14 and the LED supporting part 14a contact the side surfaces of the case 10, serving as a negative terminal.

The flashlight incorporates the head 16, the case 10 and the lid 20 all together. As the button 34a is pressed, the LED 14b is supplied with power from the batteries mounted into the battery case 22, generating light.

The light generated from the LED 14b is emitted to the outside via the reflection mirror 15 and the transparent plate 17, wherein the inclination of the reflection mirror 15 improves the collection of the light for emitting the light with the improved intensity. Therefore, the flashlight supplies light with the intensity higher than that of the prior art that employs a plurality of LEDs.

The inclination angle of the reflection mirror 15 is obtained by the test of a plurality of number of times, wherein the predetermined inclination angle should be kept for achieving the purpose of the present invention. The LED fixing part 14 and the LED supporting part 14a serve as a single negative terminal when they are in the close contacting and coupled state and simultaneously as an exothermic plate.

The battery case 22 inserted into the case 10 of the present invention secure the batteries in parallel, so that the length of the case 10 may be reduced since it is not necessary to secure the batteries in series any more.

The printed circuit board 33 mounted in the switch main body 31 is directly and respectively connected to the switch assembly 34, the battery consumption display lamp 35, the negative terminal 36 and the spring 37 connected to a lower end of a bulb 14. These elements are mounted to edge parts of the printed circuit boards and fixed to the edge parts of the printed circuit boards by soldering, thereby simplifying the assembling procedure thereof.

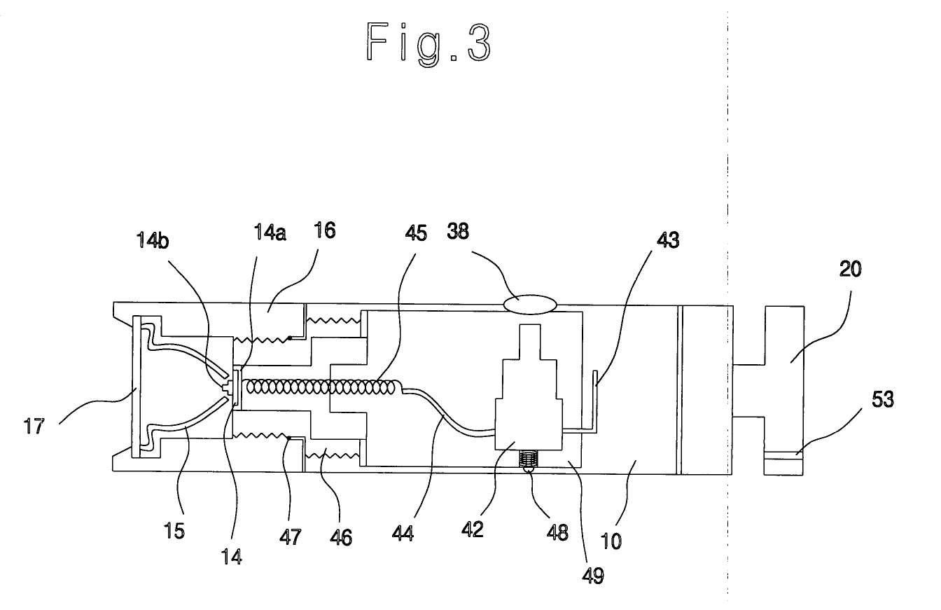

FIG. 3 is a view showing a flashlight according to another embodiment of the present invention, wherein same symbols represent the corresponding component parts of FIG. 1.

In FIG. 3 the basic structure of the flashlight is equal to that of FIG. 1, in which the head 16 is mounted with the transparent plate 17, the reflection mirror 15, the LED fixing part 14 and the LED supporting part 14a inside, and the battery case is mounted in the case 10. In FIG. 3, representing symbol 47 indicates an O-ring.

Referring to FIG. 3, a switch 42 serving as a positive terminal is mounted in the switch cover 38. The switch 42 includes a first terminal 43 exposed to the outside, a second terminal 44 connected to the LED supporting part 14a via a spring 45. An insertion part 46 is formed between the head 16 and the case 10 with a spiral part. The first and second terminals 43, 44 and the spring 45 serve as a positive terminal, and the lid 20 connected to the spring, the case 10, the insertion part 46, the LED fixing part 14, and the LED supporting part 14a serve as a negative terminal.

The spiral part of the insertion part 46 is coupled with the spiral part formed in the rear part of the head and the spiral part formed in the head part of the case 10.

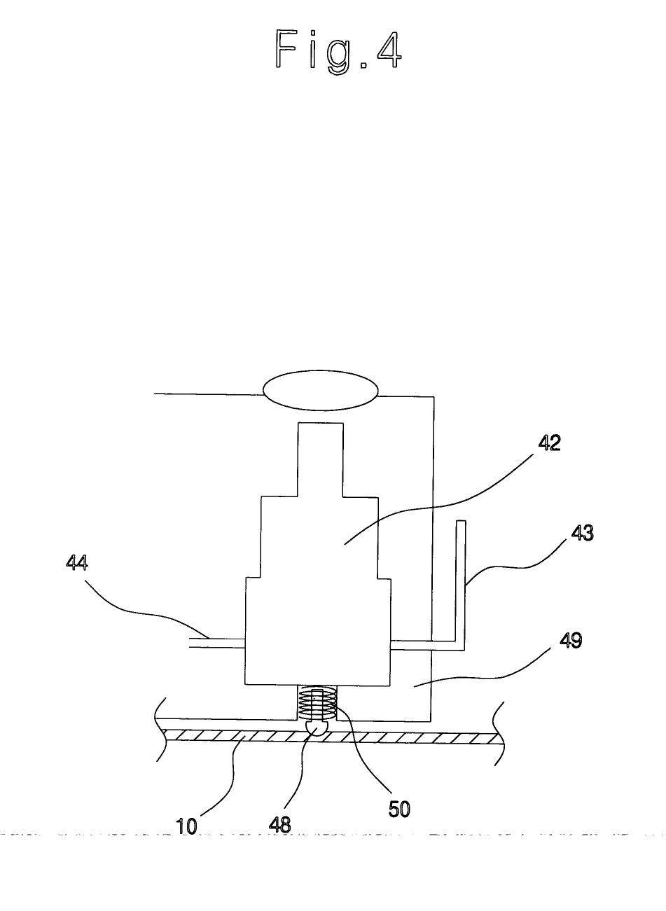

As shown in FIG. 3 and FIG. 4, a protrusion part 48 is formed at a lower part of the switch 42 via the spring for fixing the switch 42 in the case 10. When the switch 42 is inserted into the case 10, the protrusion part 48 compressed by the elasticity of the spring. As the protrusion part 48 reaches an original position after the compression, the spring reaches to its original position and the protrusion part 48 is supported by the case 10.

In the flashlight as shown in FIG. 3 and FIG. 4, positive terminals of the batteries are connected to the first terminal 43 and negative terminals of the batteries are connected to a spring(not shown) around the lid 20, as the batteries are secured in the case 10.

Therefore, if a user turns on the switch 42 via the switch cover 38, the positive terminals of the batteries are connected to the LED supporting part 42a via the first terminal 43, the switch 42, the second terminal 44, and the spring 45 in sequence, while the negative terminals of the batteries are connected to the LED 14b via the lid 20, the case 10, the insertion part 46 and the LED fixing part 14 in sequence. Therefore, the power of the batteries is applied to the LED 14b and the LED 14b emits light.

As the light emitting of the LED 14b, the light is provided to the outside strongly in the collected state via the reflection mirror 15 and the transparent plate 17.

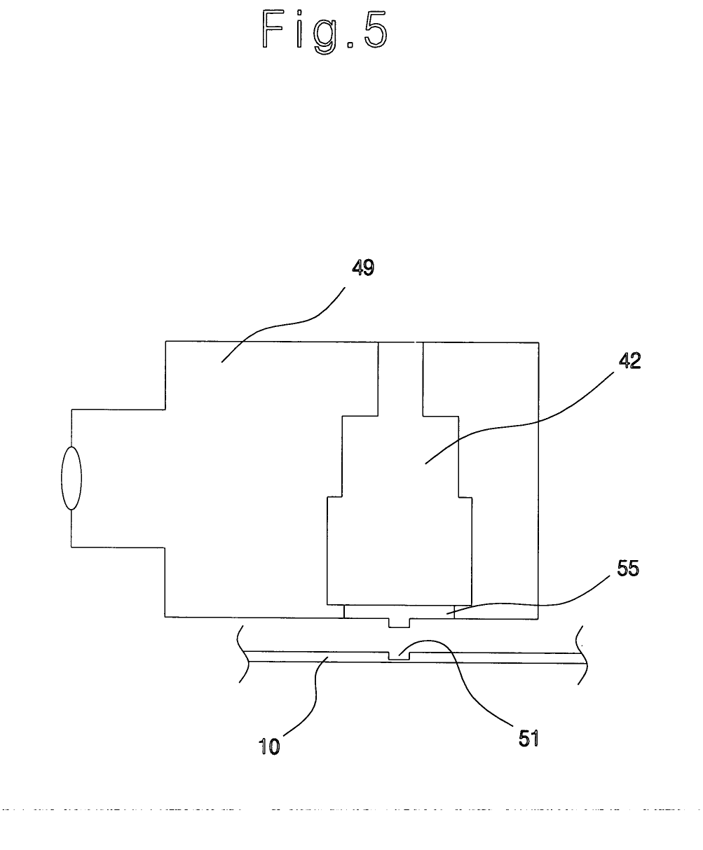

FIG. 5 shows a flashlight according to another embodiment of the present invention, wherein a main body 49 is fixed to the case 10. In FIG. 5, a protrusion 55 is mounted to a lower part of the switch 42 of the main body 49, and the case 10 is mounted with a groove part 51. Therefore, the protrusion 55 of the main body 49 is inserted and fixed in the groove part 51 of the case 10, when inserting the main body 49 into the case 10.

The protrusion 55 is restored to its original position after being pressed as a press terminal is pressed.

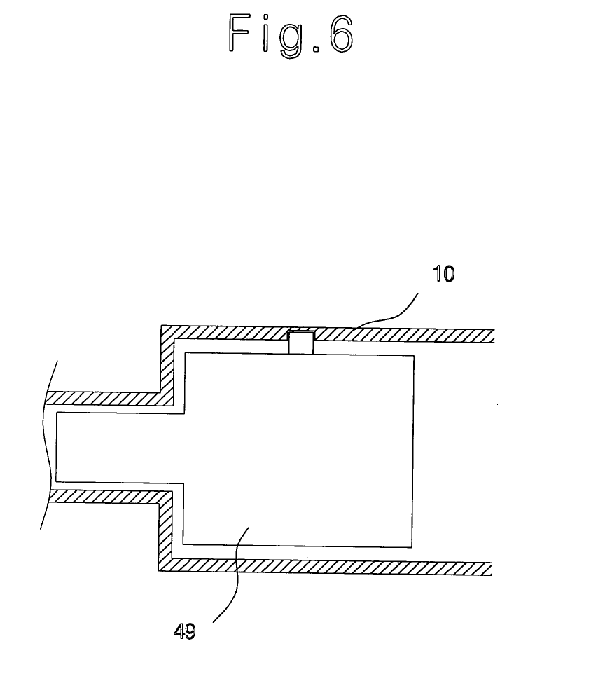

FIG. 6 is a view showing a flashlight when the main body 49 is inserted into the case 10 after removing the spiral parts and the insertion part 46 as shown in FIG. 3.

As described hereinabove, according to the present invention, the flashlight may generate light with the high intensity by using a single LED by mounting a reflection mirror around the LED with a predetermined inclination angle to collect the light of the LED to the optimum state, thereby improving the function as the flashlight, simplifying the structure and the assembling work, and reducing the manufacturing cost.

Further, the LED fixing part and the LED supporting part compressed and fixed to the rear surface of the LED serve as an exothermic plate to emit the heat generated from the LED and as a negative terminal.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. In a flashlight including a case and a head part coupled with the case, an improvement comprising a transparent plate fixed to a front surface part of the head, a reflection mirror mounted to a rear surface of the transparent plate with a predetermined inclination angle for collecting light with a reflexibility of R100.5, a circular LED fixing part mounted in the center of the reflection mirror via a hole formed in the center and fixing an LED, and a circular LED supporting part fixed to a rear surface of the LED fixing part for supporting the LED not to be deviated from the LED fixing part.

2. A flashlight according to claim 1, comprising a head coupled with the transparent plate and the reflection mirror on a front surface and an LED, an LED fixing part and the LED supporting part fixed to the center of the reflection mirror via a hole formed in the center of the reflection mirror,
the case mounted with a switch inside, a first terminal mounted to a rear surface of the switch to be exposed to the outside and a second terminal mounted to a front surface of the switch to be connected to the LED supporting part via a spring, and
an insertion part coupled between the head and the case by spiral coupling.

3. A flashlight according to claim 2, wherein the first and second terminals and the spring serve as a positive terminal, and the case, the insertion part and the LED supporting part serve as a negative terminal.
